(19) United States
(12) Patent Application Publication
(10) Pub. No.: US 2006/0253154 A1
(43) Pub. Date: Nov. 9, 2006

(54) Teething device

(76) Inventor: Ozlem K. Equils, Sherman Oaks, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/124,302

(22) Filed: May 6, 2005

(51) Int. Cl. A61J 17/00

(52) U.S. Cl. 606/235

(57) ABSTRACT

A teething device incorporating a vibratory unit and a brush unit is disclosed for use by an infant during the teething process or as a toothbrush. The teething device includes a body generally formed from two interlocking pieces, with the brush unit disposed on the top of the teething device. An interior chamber of the teething device holds a motor configured to generate vibratory forces which resonate through the brush unit to massage the gums of the infant. The brush unit is angled relative to a base of the teething device to facilitate use by the infant. The brush unit may further include one or more holes in communication with a reservoir disposed in the body, the holes being dimensioned to dispense a liquid during use of the teething device.

### FIELD OF THE INVENTION

The present invention relates generally to teething devices having a brush unit and a vibratory unit for use by infants during the teething process to massage and clean the gums. More specifically, this invention relates to such a teething device further including one or more holes disposed in the brush unit for dispensing a liquid to further alleviate the discomfort of the infant.

### BACKGROUND OF THE INVENTION

Devices used to assist infants in the teething process are well known in the art. Teething devices come in a variety of shapes and sizes, some of which may be difficult for an infant to manipulate properly. Many of the devices simply provide an area comprised of a softened plastic or rubber-like material that the infant can bite down on or chew. Some of the current teething devices include a means for producing vibrational forces throughout the device. These devices, although potentially providing a higher level of relief to the infant, are limited because they may be bulky and difficult for an infant to use. In addition, current vibrating teething devices do not provide a brush unit comprising bristles or a means for providing a soothing liquid to the infant.

Other current teething devices add a vertically oriented brush unit to the top of the teething device. In some of these devices, the brush unit is equipped with bristles that can be used to massage and clean the infant's gums. However, none of the current systems disclose or suggest a vibrating teething device which includes a brush unit and one or more holes disposed within the brush unit for dispensing a desired liquid. Current systems likewise do not disclose a vibrating teething device having a brush unit which is angled relative to the base of the teething device to facilitate usage by an infant.

### SUMMARY OF THE INVENTION

The present invention is directed to a vibrating teething device for use by an infant during the teething process. The teething device generally comprises a body of hardened plastic. The body includes an exterior face and an interior face. In a preferred embodiment, the body is substantially comprised of two interlocking pieces which are removably coupled to form the exterior of the teething unit. A central region of the body comprises a curved region to allow the infant to grip and manipulate the teething device. A top region of the body comprises a brush unit which may include one or more sets of bristles.

The interior face of the body defines an interior chamber. A vibratory unit which includes a motor and a power source is disposed within the interior chamber. When activated, the vibratory unit produces a vibratory force which resonates through the interior chamber and the brush unit of the teething device. This massaging vibration acts to soothe the pain of the infant when used during the teething process.

In one embodiment, the teething device of the present invention further comprises a reservoir disposed within the interior chamber. The reservoir is configured to hold a desired liquid that is dispensed via one or more holes within the brush unit. In various embodiments, the liquid may be dispensed via gravity pressure, biting pressure applied to the brush unit, or squeezing pressure applied to the brush unit or teething device in general.

### BRIEF DESCRIPTION OF THE DRAWINGS

FIG. 1A shows a front view of the teething device of the present invention.

FIG. 1B shows a side profile view of the teething device of the present invention.

FIG. 2A shows an interior view of the teething device of the present invention.

FIG. 2B shows a side view of the interior of the teething device of the present invention.

FIG. 3A illustrates a front view of an alternative embodiment of the teething device of the present invention.

FIGS. 3B and 3C show side profile views of the alternative embodiment of FIG. 3A.

FIG. 4A shows a side view of an alternative embodiment of the teething device of the present invention.

FIG. 4B shows a side profile view of the alternative embodiment shown in FIG. 4A.

### DETAILED DESCRIPTION OF THE PREFERRED EMBODIMENTS

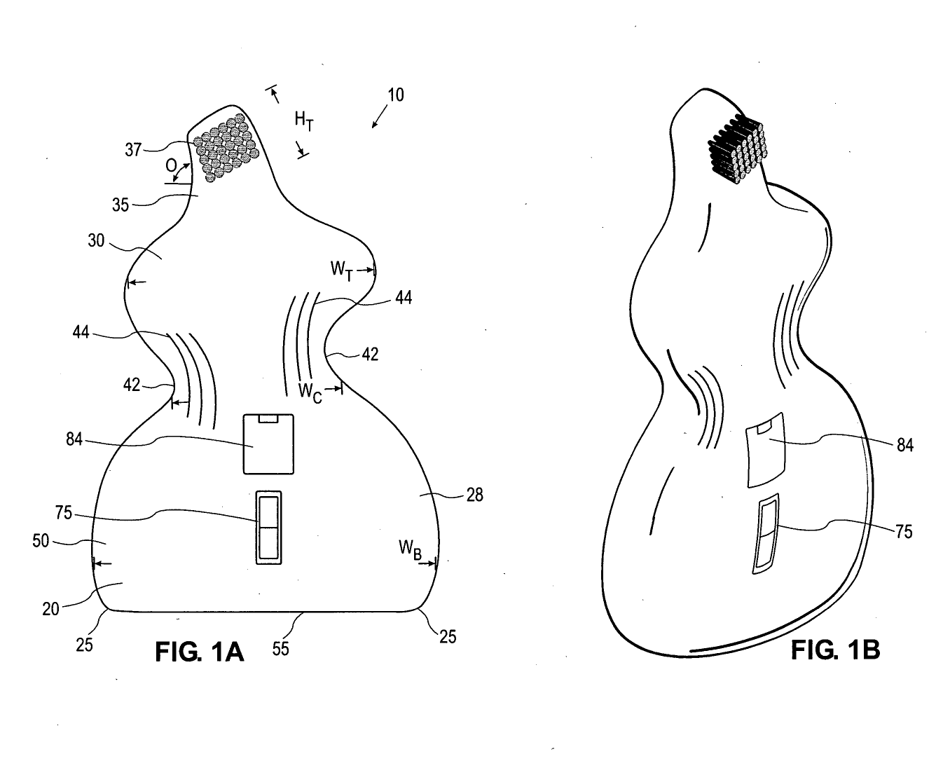

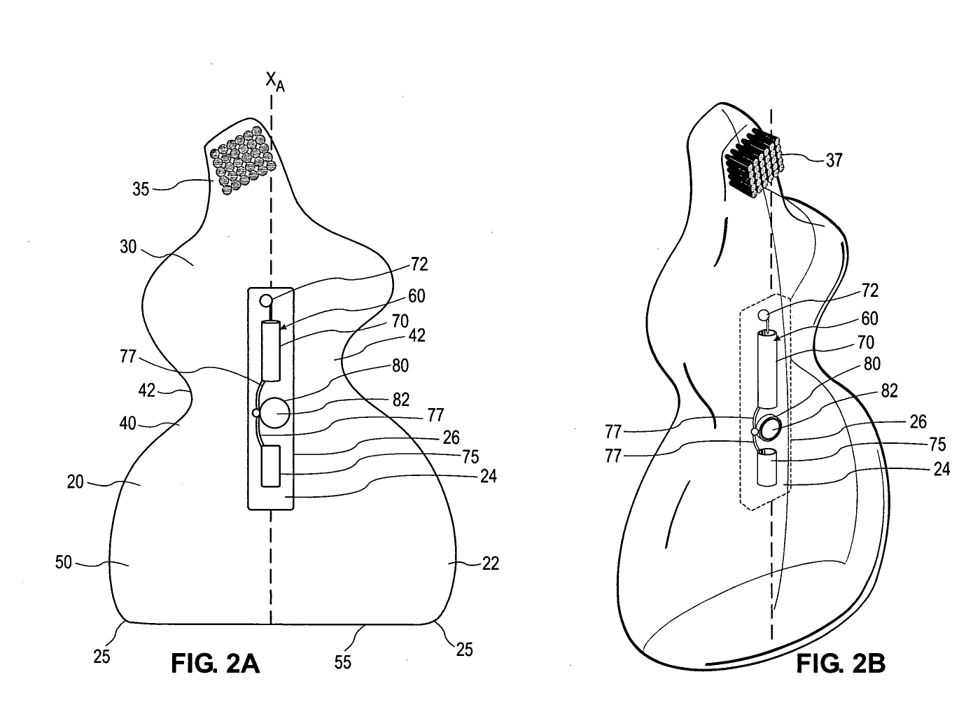

Turning to the figures, the teething device 10 of the present invention comprises a body 20 including a brush unit 35 and a vibratory unit 60 enclosed within an interior chamber 24 of the body 20 (FIGS. 1A and 2A). Body 20, which may be fabricated from a hardened plastic or similar material, includes an exterior face 28 and an interior face 22. In general, body 20 is comprised of two interlocking pieces that mate together to form a liquid tight seal. Alternatively, body 20 may be comprised of a single molded piece or more than two interlocking pieces. Curved or rounded edges 25 on body 20 prevent corners or edges of the teething device 10 from hurting an infant. The exterior face 28 of body 20 may incorporate design features such as varied colors, characters or raised surfaces which make the teething device 10 more attractive to an infant. The shape of the body is preferably an oval or a circle, similar to a contoured baby bottle.

Body 20 includes a top region 30, a central region 40, and a bottom region 50 with a base 55. As discussed further below, the top region 30 of body 20 supports a brush unit 35. The base 55 of the teething device 10 is preferably substantially flat to allow the teething device 10 to stand upright on a flat surface, in a stand, or in a recharging unit without exposing brush unit 35 to the ground or floor.

The central region 40 of teething device 10 includes a necked region 42 dimensioned to allow infants of varying ages to easily grip the teething device. Necked region 42 typically has a reduced circumference or width W_{C} as compared to the width W_{T} of the top region or the width W_{B} of the bottom region of the body 20. The exterior face 28 of central region 40 may be formed with grooves, raised dots or lines, indentions, or other surface features 44 to facilitate an infant in holding the teething device 10. Alternatively, the exterior face 28 of the teething device may be substantially smooth.

The top region 30 of teething device 10 supports brush unit 35 and exhibits an area of greater width or circumference W_{T} as compared to the width or circumference W_{C} of necked region 42. Top region 30 of the teething device is dimensioned so as to prevent an infant from choking on the teething device. The width W_{T} of top region 30, except for the brush unit 35 and the area adjacent the brush unit, should be in the range of 2 to 2 and ½ inches, which is larger than the typical width of an infant's mouth. The height H_{T} of brush unit 35 typically will be less than 1 and ½ inch to prevent an infant from inserting the brush unit too far into the back of its mouth.

Brush unit 35 may be fabricated from hardened plastic similar to the remainder of body 20. But in a preferred embodiment, brush unit 35 is made of a softer plastic such as that used in a standard toothbrush, or a rubber-like material. The softer material may reduce the stress caused to the mouth of an infant from biting on the brush unit. Brush unit 35 may be rounded, include one or more flat surfaces, or be of any other shape known in the art. In a preferred embodiment, the shape of brush unit 35 is either rounded or substantially rectangular and does not contain sharp edges that could damage the gums of an infant. Brush unit 35 also includes one or more sets of bristles 37. These bristles may assist in cleaning the infant's teeth and clean and massage the gums. By including bristles, the teething device may also be used by infants and toddlers as a toothbrush. Bristles 37 may be disposed on one side of brush unit 35 or on more than one side of brush unit 35. The number, size, and arrangement of bristles 37 may be varied as desired.

In a preferred embodiment, the top region 30 of teething device 10 is angled such that brush unit 35 is not vertically oriented relative to base 55. Preferably brush unit 35 is arranged at an angle θ about 40 to 80 degrees relative to base 55 (FIG. 1). Most preferably, angle θ is approximately 50 to 75 degrees relative to base 55. By angling brush unit 35, the brush unit can reach a greater portion of the infant's gum line than would be the case if the brush unit were oriented in a straight, vertical fashion. Thus, the infant can more easily direct the brush unit to the desired area of its mouth.

The vibratory unit 60 of teething device 10 comprises a motor 70, a power supply 80, a switch 75 to activate the motor 70, and electrical connections 77 arranged between these components (FIGS. 2A and 2B) in a manner known to those of ordinary skill in the art. Power supply 80 and motor 70 are preferably contained with an interior chamber 24. The interior chamber 24 is defined by a frame 26 on the interior face 22 of body 20. Frame 26 is preferably fabricated from a hardened plastic. Electric motor 70 used with the device of the present invention may be any type of motor known in the art. Preferably, motor 70 is a low voltage motor. In addition, the motor typically is compact and lightweight to reduce the overall size and weight of the teething device to allow for greater manipulation of the teething device by an infant. When activated, motor 70 provides a gentle vibration or rotation to brush unit 35 and/or bristles 37 of the teething device.

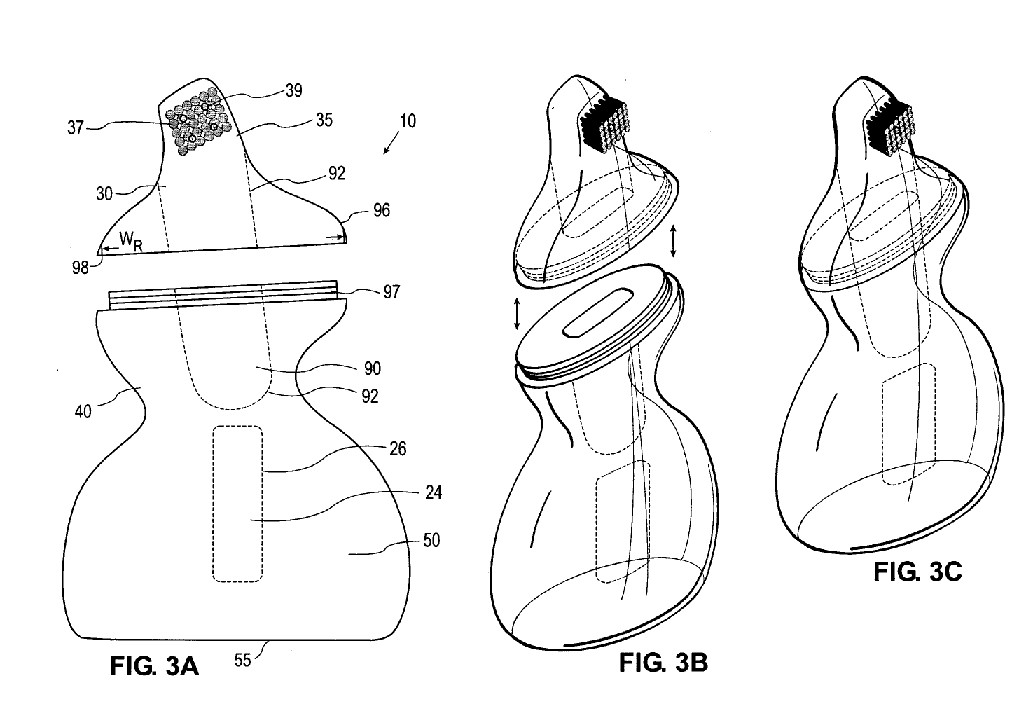

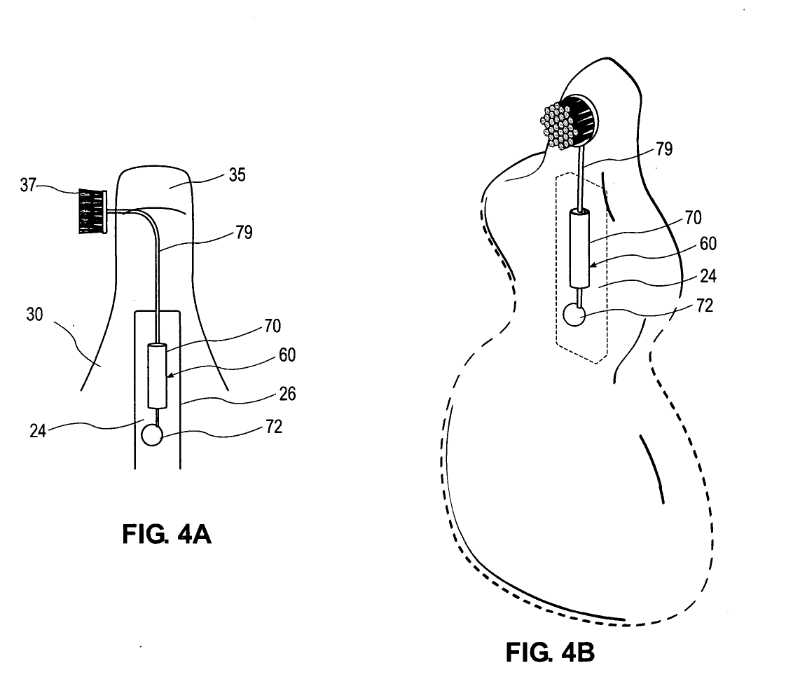

The location of motor 70 may be varied depending on the features of teething device 10. As described in greater detail below, in one embodiment, the teething device includes a reservoir 90 which holds a liquid. In a teething device having such a reservoir 90, motor 70 is disposed below the reservoir in the central region 40 or bottom region 50 of the teething device (FIG. 3A). Alternatively, motor 70 may be disposed within or just below brush unit 35. In an embodiment which does not have a reservoir 90 for liquid, motor 70 may be disposed within or just below brush unit 35 to more accurately concentrate the vibrational or rotational force on the brush unit (FIG. 2A). In either embodiment, motor 70 is configured to provide a soothing, massaging vibration to the infant's gums when the motor is activated. In a further embodiment, there is a physical connection 79 between motor 70 and brush unit 35 (FIGS. 4A and 4B). In this embodiment, activation of the motor may initiate circular rotation of the bristles 37 attached to the brush unit as in a standard electric toothbrush.

Motor 70 is preferably located substantially along a longitudinal axis X_{A} of the teething device 10 (FIG. 2A). In another embodiment, motor 70 may be disposed to one side of the longitudinal axis X_{A} to provide stability to the teething device when placed on a flat surface. The motor may include an offset or eccentric weight 72 coupled with the motor in a manner known to those of ordinary skill in the art. Activation of the motor results in rotation or other movement of the eccentric weight 72. Movement of eccentric weight 72 creates a vibratory force that resonates through the interior chamber 24 to the body 20 of teething device 10. Other known forms of motors 70 which create a vibratory force are also within the scope of this invention.

Motor 70 is connected to power supply 80 and switch 75 via electrical connections 77, e.g., one or more conductive plates and wires, or by any means known in the art. In a preferred embodiment, power supply 80 is comprised of one or more small, flat disc batteries 82. The use of a small battery 82 reduces the overall weight and profile of the teething device 10. A reduced overall weight allows for greater manipulation of the teething device by an infant, thereby providing greater relief from teething discomfort. In addition, lessening the weight of teething device 10 will reduce the risk of injury to the infant from dropping the teething device. Battery 82 is preferably accessed via a battery cover or battery cap 84 (FIG. 1A). Battery cap 84 creates a water-tight seal to preclude damage to the electromechanical components of the teething device. Battery cap 84 may be screwed into body 20, slide into the body, or be removably secured to the body by any other means known in the art.

In a further embodiment, battery 82 may be a rechargeable battery. Battery 82 may be recharged by inserting the base of teething device 10 in a recharging unit (not shown). In this embodiment, teething device 10 may be manufactured with the rechargeable battery integrated into the teething device such that the rechargeable battery cannot be removed from the teething device. The teething device of this embodiment may therefore not require a battery cover 84. Alternatively, teething device 10 includes a battery cover 84 to allow for replacement of the rechargeable battery.

Teething device 10 also includes a switch 75 to activate vibratory unit 60. Preferably switch 75 comprises a standard flip switch that can be easily manipulated by an infant. Switch 75 typically will have a reduced profile to prevent inadvertent activation or deactivation of the motor. Other forms of switches such as button switches, slide switches, and other switches known in the art may also be used. Preferably switch 75 maintains a water-tight seal in either the activated or deactivated position to prevent malfunction of the electrical components of teething device 10 or potential injury to the infant.

As suggested above, teething device 10 may include a reservoir 90. One or more holes 39 disposed in brush unit 35 are designed to dispense a liquid from the reservoir when an infant is using the teething device (FIGS. 3A-3C). In this embodiment, the top region 30 of teething device 10 includes a cap 96 that is removable to access reservoir 90, thereby allowing the reservoir to be filled or refilled. In a further embodiment, removal of cap 96 may also allow a user to replace battery 82. The width W_{R} of the cap is preferably at least 2 and ½ inches to prevent choking of an infant if the cap is inadvertently removed.

In a preferred embodiment, cap 96 is securely screwed to the body 20 of teething device 10. This will preserve a liquid tight seal and prevent the infant from removing the cap from the body. Cap 96 may be formed with threaded grooves 98 which mate with threaded grooves 97 on the body 20 of teething device 10. Alternatively, cap 96 may be removably coupled to the body by other means known in the art.

Reservoir 90 may comprise a plastic lined cavity 92 such as that found in a typical baby bottle. During use, the reservoir may be filled with water of varying temperatures, juice, liquid medication, or any other liquid. The liquid dispensed through holes 39 in teething device 10 may vary depending on the needs of the child and should not be limited to the examples discussed herein.

In a preferred embodiment, the diameter of each hole 39 disposed in brush unit 35 for dispensing liquid is approximately the size of a pin hole, 0.1 mm, but may vary from 0.01 mm to 0.5 mm. The liquid may be dispensed via gravity pressure such that each hole 39 dispenses the liquid at the rate of about one drop every three seconds. Alternatively, if brush unit 35 is fabricated from a softer material, biting pressure applied to the brush unit may be used to dispense liquid via the holes 39. In this embodiment, the rate that the liquid is dispensed from reservoir 90 is dependent on the amount of biting pressure applied by the infant. In yet another embodiment, body 20 may be fabricated from a softer material, and squeezing pressure applied by the infant may determine the rate at which the liquid is dispensed.

In operation, teething device 10 is first filled with a desired liquid after the reservoir cap 96 has been removed from the body 20 of the teething device. The liquid chosen may depend on the needs of the child. Typically reservoir 90 will be filled with cold water to provide a soothing, cool liquid to the infant. Reservoir 90 may also filled with a dose of infant pain medication to further relieve the pain of the infant.

Once the reservoir has been filled, reservoir cap 96 is re-attached to the teething device. The cap should be fittingly secured to the body 20 of the teething device so as to prevent leakage of the liquid out of the reservoir. The massaging function of teething device 10 can then be activated by actuating switch 75. Switch 75 is designed to be able to be activated by the infant. The teething device is grasped by the infant and manipulated by the infant to the desired location within his or her mouth. Brush unit 35 of the teething device is designed to be angled and dimensioned such that an infant can easily reach all portions of his or her mouth and gums.

While the invention is susceptible to various modifications and alternative forms, specific examples thereof have been shown in the drawings and herein described in detail. It should be understood, however, that the invention is not to be limited to the particular forms or methods disclosed; rather, the intention is to cover all modifications, equivalents, and alternatives falling within the spirit and scope of the appended claims.

What I claim is:

1. A teething device comprising
a body including a top region, a central region, and a bottom region having a substantially flat base;
a necked region within the central region having a reduced circumference compared to a circumference of the top region and a circumference of the bottom region; and
a brush unit disposed on the top region at an angle between 40 and 80 degrees relative to the base.

2. The teething device of claim 1, further comprising:
a reservoir for holding a liquid wherein the reservoir is disposed within the top region of the teething device; and
one or more holes disposed within the brush unit for dispensing the liquid, wherein the one or more holes are in communication with the reservoir.

3. The teething device of claim 2, wherein the one or more holes have a diameter between 0.01 mm to 0.5 mm.

4. The teething device of claim 2, wherein the brush unit is configured to dispense liquid via the one or more holes at a rate determined by the amount of biting pressure applied to the brush unit by an infant.

5. The teething device of claim 1, further comprising
a vibratory unit including a motor and a power source; and
an interior chamber dimensioned to receive the vibratory unit.

6. The teething device of claim 5, further comprising an eccentric weight coupled with the motor which is displaced when the motor is activated.

7. The teething device of claim 5, further comprising a switch for activating the motor.

8. The teething device of claim 5, wherein the power source comprises a battery.

9. The teething device of claim 5, wherein the power source comprises a rechargeable battery.

10. The teething device of claim 1, further comprising one or more bristles attached to the brush unit.

11. The teething device of claim 10, wherein the bristles are disposed on one side of the brush unit.

12. The teething device of claim 10, wherein the bristles are disposed on more than one side of the brush unit.

13. The teething device of claim 1, wherein the central region includes surface features.

14. The teething device of claim 13, wherein the surface features comprise grooves.

15. The teething device of claim 13, wherein the surface features comprise raised dots.

16. The teething device of claim 1, wherein the angle of the brush unit relative to the base of the bottom region is between 50 and 75 degrees.

17. A method of massaging the gums of an infant comprising
applying a vibratory force to the gums by directing a teething device to the gums, the teething device including a body and a brush unit disposed on a top region of the body, the teething device further including a motor unit configured to create a vibratory force; and
dispensing a liquid from one or more holes disposed in the brush unit.

18. The method of claim 17 further comprising
brushing the gums with one or more sets of bristles, said bristles being disposed on the brush unit of the teething device.
